(19) United States
(12) Patent Application Publication
(10) Pub. No.: US 2005/0026651 A1
(43) Pub. Date: Feb. 3, 2005

(54) Cellular phone for multiple way call

(75) Inventor: Yu-Sheng Chen, Taipei Hsien (TW)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei Hsien (TW)

(21) Appl. No.: 10/627,613

(22) Filed: Jul. 28, 2003

(51) Int. Cl. H04M 1/00; H04M 3/42

(52) U.S. Cl. 455/556.1; 455/66.1; 455/416; 455/518; 455/553.1; 455/41.2

(57) ABSTRACT

The present invention is to provide a cellular phone for multiple way call, which comprises IR device, the IR device being activated when the cellular phone is in connection with a base station for conveying speeches with a plurality of second cellular phones nearby each having the IR device so that the cellular phone is able to carry out multiple way call with the second cellular phones for discussion via the base station or vice versa.

### FIELD OF THE INVENTION

The present invention relates to cellular phones and more particularly to a cellular phone capable of carrying out multiple way call with a plurality of cellular phones of the same type.

### BACKGROUND OF THE INVENTION

More and more people like to use cellular phones for conveying speeches with friends or partners in a real time manner due to advantages of the cellular phone such as compactness, powerfulness, and inexpensiveness. Moreover, as compared with conventional telephones, cellular phones have additional advantages such as simpleness, quickness, etc. Recently, there is a trend of designing and developing slim, compact, lightweight, and small cellular phones among cellular phone manufacturers. Further, the functions of a cellular phone gradually incorporate features of many consumer electronic products to form a multifunctional cellular phone for meeting the needs of vast consumers. However, one drawback of the prior cellular phone is that it only allows a party, by using a cellular phone, to convey speeches with the counterpart who is using another cellular phone via a base station or vice versa. In other words, the prior cellular phone does not provide the feature of multiple way call, i.e., one cellular phone user conveys speeches with two or more cellular phone users simultaneously. For example, this need may occur when a topic or problem is discussed among several persons by using cellular phones. This is really inconvenient.

Thus, it is desirable among communication product producers to provide a cellular phone capable of carrying out multiple way call with a plurality of cellular phones of the same type in order to overcome the above drawback of the prior art.

### SUMMARY OF THE INVENTION

A primary object of the present invention is to provide a cellular phone for multiple way call. The cellular phone comprises IR device, the IR device being activated when the cellular phone is in connection with a base station for conveying speeches with a plurality of second cellular phones nearby each having the IR device so that the cellular phone is able to carry out multiple way call with the second cellular phones for discussion via the base station or vice versa. By utilizing the present invention, the above drawback of the prior art, only allowing a cellular phone user to convey speeches with another cellular phone user or vice versa, can be overcome.

The above and other objects, features and advantages of the present invention will become apparent from the following detailed description taken with the accompanying drawings.

### BRIEF DESCRIPTION OF THE DRAWINGS

FIG. 1 illustrates a cellular phone capable of carrying out multiple way call with a plurality of cellular phones of the same type according to the invention; and

FIG. 2 is block diagram of the cellular phone shown in FIG. 1.

### DETAILED DESCRIPTION OF THE PREFERRED EMBODIMENTS

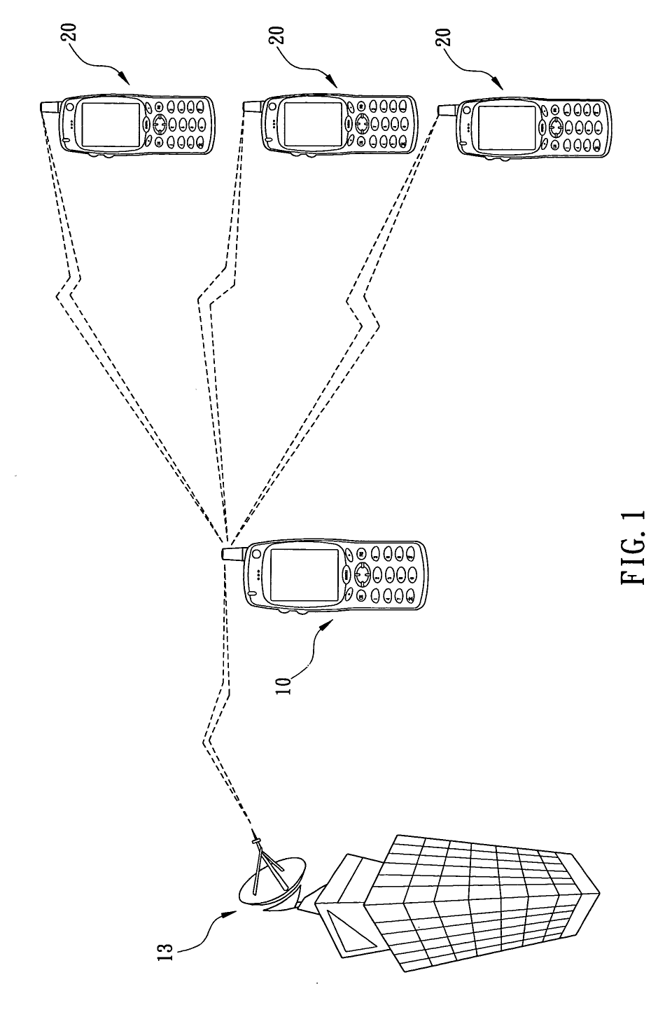

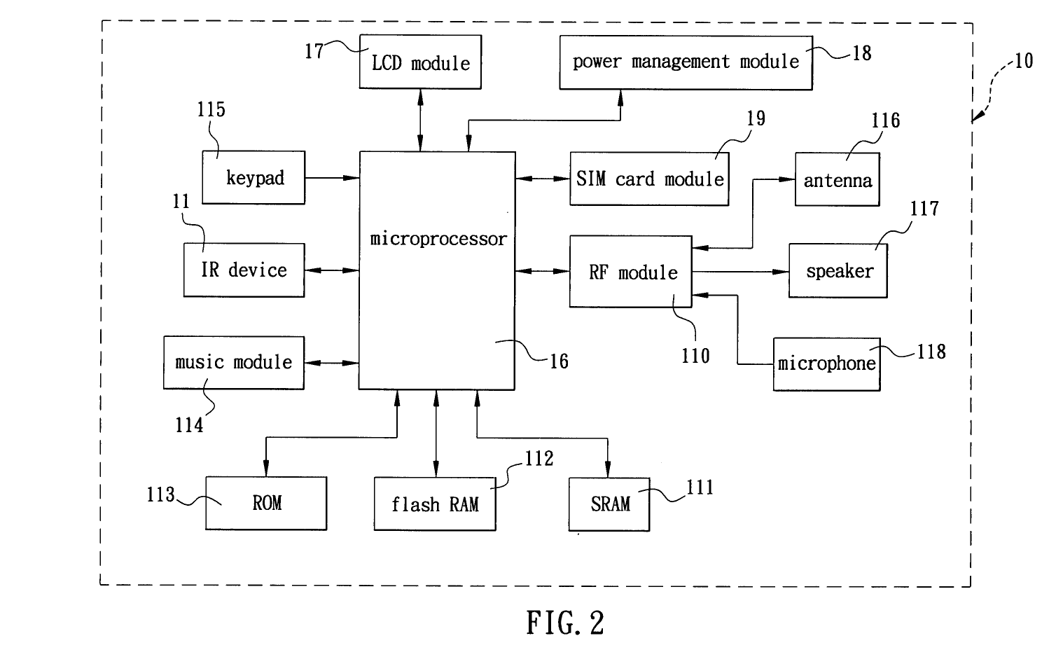

Referring to FIGS. 1 and 2, a cellular phone capable of carrying out multiple way call with a plurality of cellular phones of the same type in accordance with the invention is illustrated. The invention is provided to overcome the prior drawback of only allowing a cellular phone user to convey speeches with another cellular phone user or vice versa. An IR (infrared) device 11 is provided in a cellular phone 10. The IR device 11 is activated when the cellular phone 10 is in connection with a base station 13 for conveying speeches with a plurality of nearby cellular phones 20 each having the same type of IR device 11. As such, the cellular phone 10 is capable of carrying out multiple way call with the cellular phones 20 via the base station 13 or vice versa.

Referring to FIG. 1, in the invention the cellular phone 10 is coupled to an external speaker. Hence, at the same time speeches conveyed by the cellular phone 10 can be broadcasted to enable several persons to hear it by means of the speaker.

Referring to FIG. 2, in the invention the cellular phone 10 further comprises a microprocessor 16, a liquid crystal display (LCD) module 17, a power management module 18, a SIM (Subscriber Identity Module) card module 19, an RF (radio frequency) module 110, a SRAM (Static Random Access Memory) 111, a flash RAM (Random Access Memory) 112, a ROM (Read-Only Memory) 113, a music module 114, and a keypad 115. The microprocessor 16 is adapted to show processed data on an LCD of the cellular phone 10 by means of the LCD module 17. The power management module 18 is controlled by the microprocessor 16 to supply power of a battery of the cellular phone 10 to each component of the cellular phone 10. The SIM card module 19 comprises a SIM slot. Hence, the microprocessor 16 is adapted to communicate codes stored on a SIM card inserted in the SIM slot with a base station of a telephone company.

Referring to FIG. 2 again, the RF module 110 comprises an antenna 116, a speaker 117, and a microphone 118. The RF module 110 is controlled by the microprocessor 16 to activate the antenna 116 for receiving RF signals transmitted from the base station of the telephone company. The RF signals are then converted into sound signals which are in turn converted into sound prior to amplifying by the speaker 117. As such, a cellular phone user can hear speeches from the counterpart. Alternatively, the RF module 110 is controlled by the microprocessor 16 to convert speeches of a cellular phone user into sound waves through the microphone 118 which are in turn converted into RF signals. The RF signals are then transmitted to the base station of the telephone company via the antenna 116. This completes all processing of a call.

Referring to FIG. 2 again, the microprocessor 16 is adapted to store processed data in the SRAM 111 for carrying out a time division multiplex processing. The microprocessor 16 is adapted to either store user input data (e.g., telephone number) in the flash RAM 112 or read data from the flash RAM 112. The microprocessor 16 is adapted to read stored programs from the ROM 113 and process the same by executing the programs. The music module 114 is controlled by the microprocessor 16 to broadcast music signals from the speaker 117 in which the music signals are read from the flash RAM 112 by the microprocessor 16. A user can either input data by operating keys of the keypad 115 or make a call.

Referring to FIG. 1 again, in such a manner a cellular phone 10 user can activate the IR device 11 of the cellular phone 10 to discuss a topic or problem with several persons who are also using cellular phones of the same type. This is very convenient.

While the invention has been described by means of specific embodiments, numerous modifications and variations could be made thereto by those skilled in the art without departing from the scope and spirit of the invention set forth in the claims.

1. A cellular phone for multiple way call, comprising:
IR device, the IR device being activated when the cellular phone is in connection with a base station for conveying speeches with a plurality of second cellular phones nearby each having the IR device so that the cellular phone is able to carry out multiple way call with the second cellular phones via the base station or vice versa.

2. The cellular phone of claim 1, further comprising a speaker coupled to the cellular phone from outside so that speeches conveyed by the cellular phone can be broadcasted by means of the speaker.

3. The cellular phone of claim 1, wherein the cellular phone further comprises an LCD module and a microprocessor for showing processed data on an LCD of the cellular phone by means of the LCD module.

4. The cellular phone of claim 3, wherein the cellular phone further comprises a power management module, the power management module being controlled by the microprocessor to supply power of a battery of the cellular phone to each component of the cellular phone.

5. The cellular phone of claim 4, wherein the cellular phone further comprises a SIM card module having a SIM slot so that the microprocessor is adapted to communicate codes stored on a SIM card inserted in the SIM slot with a base station of a telephone company.

6. The cellular phone of claim 5, wherein the cellular phone further comprises an RF module including an antenna, a speaker, and a microphone, the RF module being controlled by the microprocessor to activate the antenna for receiving RF signals transmitted from the base station of the telephone company, and the RF signals being converted into sound signals which are converted into sound prior to amplifying by the speaker or the RF module being controlled by the microprocessor to convert speeches of a call into sound waves which are converted into RF signals, and the RF signals being transmitted to the base station of the telephone company via the antenna.

7. The cellular phone of claim 6, wherein the cellular phone further comprises a SRAM so that the microprocessor is adapted to store processed data in the SRAM for carrying out a time division multiplex processing.

8. The cellular phone of claim 7, wherein the cellular phone further comprises a flash RAM so that the microprocessor is adapted to either store user input data in the flash RAM or read data from the flash RAM.

9. The cellular phone of claim 8, wherein the cellular phone further comprises a ROM so that the microprocessor is adapted to read stored programs from the ROM and process the same by executing the programs.

10. The cellular phone of claim 9, wherein the cellular phone further comprises a music module so that in response to reading music signals from the flash RAM by the microprocessor, the music module is controlled by the microprocessor to broadcast the music signals from the speaker.

11. The cellular phone of claim 10, wherein the cellular phone further comprises a keypad so that it is capable of either operating keys of the keypad to input data or making a call.
